(19) United States
(12) Patent Application Publication
(10) Pub. No.: US 2007/0169095 A1
(43) Pub. Date: Jul. 19, 2007

(54) Memory module for a projection system

(75) Inventors: Wen-Chang Chien, Miao Li County (TW); Kun-Lin Hsieh, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/541,723

(22) Filed: Oct. 3, 2006

(30) Foreign Application Priority Data
Nov. 11, 2005 (TW) 94139639

(51) Int. Cl. G06F 9/44

(52) U.S. Cl. 717/168

(57) ABSTRACT

A memory module includes a memory device having an initial memory address, a fixed memory address and a language storage region that is used for storing an essential language therein and that extends from the fixed memory address and an update module for updating the essential language beginning from the fixed memory address.

### FIELD OF THE INVENTION

The present invention relates to a memory module, and more particularly to a memory module that is use in a projection system and that is capable of updating a language stored therein.

### BACKGROUND OF THE INVENTION

FIG. 1 is a conventional memory module 2 for a projection system which includes a memory device 4 (such as a Flash Memory Card) that contains a language storage region 408 for storing at least one language to be utilized for on-screen display and a designated region 10. The designated region 10 includes a boot block 402 containing system startup information and instruction necessary to boot a CPU (central processing unit), a critical code block 403 containing critical codes for supplying interrupt vector addresses, a read/write data block 404 containing data for performing reading and writing operations, and an executable code block 406 containing execution codes and programs.

The memory device 4 has a plurality of memory addresses. FIG. 1 is a block diagram illustrating the memory addresses beginning from 0x000000 and terminating at 0xFFFFFF. The boot block 402 extends from an initial memory address (0x000000). The critical code block 403 extends from the boot block 402 beginning at a first fixed memory address (0x004000). The read/write data block 404 extends from the critical code block 403 beginning at a second fixed memory address (0x008000). The executable code block 406 extends from the read/write data block 404 beginning at a terminating memory address (0xXXXXXX). Since the terminating memory address of the read/write data block 404 varies according to the size of the read/write data and since the language storage region 408 follows immediately after the executable code block 406, the initial memory address of the language storage region 408 cannot be located at a fixed position after the executable code block 406.

In addition, when the projection system equipped with the conventional memory module is shipped to a different region or country and in the event of updating the existing language or loading a new language in order to adapt with the country, reading or loading operation is usually conducted beginning from the designated region 10. In other words, the reading operation is conducted beginning from the boot block 402 up to the executable code block 406 so as to locate the initial memory address of the language storage region 408. The updating of the language can be conducted only after locating the initial memory address of the language storage region 408. This takes a relatively long time for burning or updating the language, and annoys the user. In case the conventional memory module is not compatible with the available burning system, some additional memory parts must be added into the conventional memory module, which, in turn, may cause extra burden to the user of the projection system.

### SUMMARY OF THE INVENTION

The object of the present invention is to provide an actuating module for use in a disk drive of slim type. The actuating module includes a flexible flat cable of a unique structure having the flexibility for avoiding the drawback encountered during mounting of the same onto the magnetic plunger in order to form the actuating module.

In accordance with the present invention, a memory module is provided for use in a projection system. The memory module includes: a memory device having an initial memory address and a fixed memory address, the memory device including a language storage region that is used for storing at least an essential language and that extends from the fixed memory address; and an update module for updating the essential language beginning from the fixed memory address.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a block diagram illustrating a conventional memory module for use in a projection system;

FIG. 2 shows a block diagram illustrating a projection system provided with a memory module of the present invention; and

FIG. 3 shows a block diagram illustrating the memory device of the present invention.

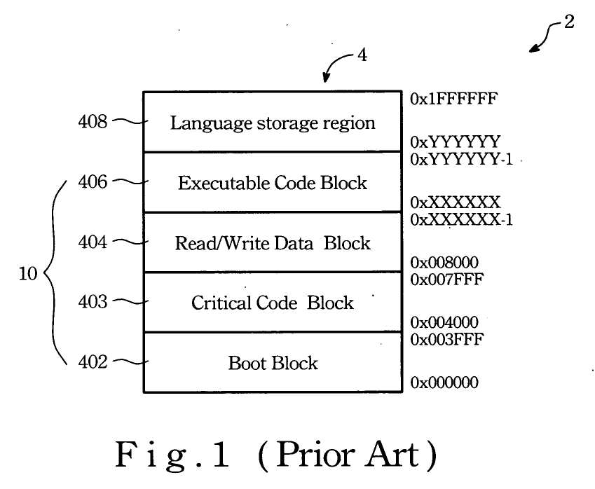

### DETAILED DESCRIPTIONS OF THE PREFERRED EMBODIMENT

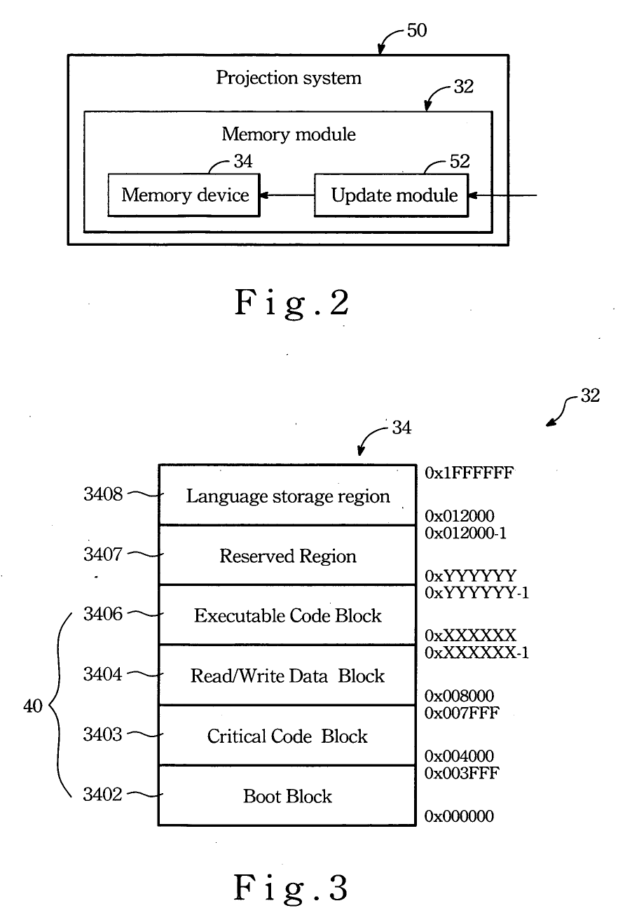

FIG. 2 shows a projection system 50 provided with a memory module 32 of the present invention. The memory module 32 includes a memory device 34 (such as a Flash memory card) and an update module 52 that is capable of updating a language stored in the memory device 34. The memory device 34 is stored with a plurality of memory addresses, such as an initial memory address 0x000000, a first fixed memory address 0x012000-1, and a terminating memory address 0xYYYYYY. The memory device 34 includes a language storage region 3408 that is used for storing at least an essential language therein. The language can be English, Chinese or Japanese that is used for displaying on a display panel of the projection system 50 together with video images. The update module 52 includes an OSD Tool for updating contents stored in the language storage region 3408 of the memory device 34.

Referring to FIG. 2, the memory device 34 further includes a designated region 40 and a reserved region 3407 in addition to the language storage region 3408. The designated region 40 extends from the initial memory address 0x000000 (see FIG. 3) while the reserved region 3407 extends from the terminating memory address 0xYYYYYY (see FIG. 3) of the designated region 40 and terminates at the first fixed memory address 0x012000-1. The language storage region 3408 begins from a second fixed memory 0x012000 and terminates at the terminating memory address 0xYYYYYY address (see FIG. 3). In fact, the number of the memory addresses should not be limited to the aforementioned ones, but can be adjusted in such a manner to be complement with the storage space of the memory device 34.

When the projection system 50 provided with the memory module 32 of the present invention is shipped to another place or country and in order to conform the language with the assigned country, the language stored in the language storage region 3406 must undergo an updating operation. Under this condition, the update module 52 is required to update the language stored in the language storage region 3408 beginning from the second fixed memory 0x012000, and not from the initial memory address 0x000000. Thus, the updating operation takes only a relatively short time when compared to the conventional memory module.

Similar to the conventional memory device, the designated region 40 of the memory device 34 of the present invention further includes a includes a boot block 3402 extending from the initial memory address 0x000000 and terminating at a memory address 0x003FFF, a critical code block 3403 extending from the boot block 3402 and terminating at a memory address 0x008000, a write/read data block 3404 extending from the critical code block 3403 and terminating at a memory address 0xXXXXXX-1, and an executable code block 3406 extending from said write/read data block 3404 and terminating at a memory address 0xYYYYYY-1. Since the purpose of forming the aforesaid blocks remain the same in the prior art, a detailed explanation thereof is omitted herein for the sake of brevity.

In summary, since the projection system 50 is equipped with the memory module 32 of the present invention and since the update module 52 employed in the memory module 32 updates or changes the language beginning from the predetermined fixed memory address 0x012000 onward, only a relatively short time is required to conduct the updating, burning or changing operation. The memory module 32 thus complies with the present available market (or trend). The process of testing the validity of the memory module 32 is also simplified.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A memory module for use in a projection system, comprising:
a memory device having an initial memory address and a fixed memory address, the memory device including a language storage region that is used for storing at least an essential language therein and that extends from said fixed memory address; and
an update module for updating said essential language beginning from said fixed memory address.

2. The memory module according to claim 1, wherein said essential language stored in said storage region is used to be displayed on a display panel of the projection system.

3. The memory module according to claim 1, wherein said memory device further includes a designated region extending from said initial memory address and a reserved region 3407 terminating at said fixed memory address.

4. The memory module according to claim 3, wherein said designated region includes a boot block extending from said initial memory address, a critical code block extending from said boot block, a write/read data block extending from said critical code block, and an executable code block extending from said write/read data block.

5. The memory module according to claim 1, wherein said update module further includes an OSD Tool for updating contents stored in said language storage region of said memory device.

6. The memory module according to claim 1, wherein said memory device is a Flash Memory Card.
